(19) United States
(12) Patent Application Publication
(10) Pub. No.: US 2026/0235991 A1
(43) Pub. Date: Aug. 13, 2026

(54) OSCILLATION MITIGATION FOR ANIMATED FIGURES

(71) Applicant: Universal City Studios LLC, Orlando, FL (US)

(72) Inventors: Timothy J. Eck, Orlando, FL (US); Venkata Krishna Tamminana, Orlando, FL (US)

(21) Appl. No.: 19/532,114

(22) Filed: Feb. 6, 2026

Related U.S. Application Data
(60) Provisional application No. 63/758,590, filed on Feb. 14, 2025.
(60) Provisional application No. 63/755,553, filed on Feb. 7, 2025.

(51) Int. Cl. G05B 11/42; B25J 19/02

(52) U.S. Cl. CPC G05B 11/42; B25J 19/02

(57) ABSTRACT

An animated figure system includes an animated figure having a body. The animated figure system further includes one or more actuators configured to move the body according to a motion profile. Additionally, the animated figure system includes a plurality of inertial measurement units (IMUs) coupled to the body at a respective plurality of locations. Each IMU is configured to measure one or more motion parameters of the body. Further, the animated figure system includes a controller communicatively coupled to the one or more actuators and the plurality of IMUs. The controller is configured to determine one or more offset factors based at least on the one or more motion parameters, augment the motion profile based on the one or more offset factors to produce an adjusted motion profile, and operate the one or more actuators according to the adjusted motion profile to apply a force opposing oscillation of the body.

### CROSS-REFERENCE TO RELATED APPLICATION

This application claims priority to U.S. Provisional Application No. 63/758,590, entitled “OSCILLATION MITIGATION FOR ANIMATED FIGURES,” filed Feb. 14, 2025 and U.S. Provisional Application No. 63/755,553, entitled “OSCILLATION MITIGATION FOR ANIMATED FIGURES” and filed on Feb. 7, 2025; each of which is incorporated by reference herein in its entirety for all purposes.

### BACKGROUND

The present disclosure relates generally to an animated figure control system. More specifically, embodiments of the present disclosure relate to an animated figure control system that facilitates animation effects, such as a walking effect.

Amusement parks typically include various attractions that provide unique experiences for guests. For example, an amusement park may include various show performances. As technology has continued to improve, such attractions have increased in sophistication and complexity. There is a corresponding increase in expectations regarding entertainment quality of attractions and a need for more immersive effects. Some attractions may include animated figures(e.g., robots, puppets) to entertain park guests that are queued for or within a ride experience. An animated figure may include various mechanisms (e.g., motors, drives, pistons, actuators) configured to move the animated figure to produce an animation effect. In some cases, movement of the animated figure may produce unwanted vibrations and/or oscillations, disrupting immersion in the entertainment.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF DESCRIPTION

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, an animated figure system includes an animated figure having a body. The animated figure system further includes one or more actuators configured to move the body according to a motion profile. Additionally, the animated figure system includes a plurality of inertial measurement units (IMUs) coupled to the body at a respective plurality of locations. Each IMU of the plurality of IMUs is configured to measure one or more motion parameters of the body. Further, the animated figure system includes a controller communicatively coupled to the one or more actuators and the plurality of IMUs. The controller is configured to determine one or more offset factors based at least on the one or more motion parameters, augment the motion profile based on the one or more offset factors to produce an adjusted motion profile, and operate the one or more actuators according to the adjusted motion profile to apply a force opposing oscillation of the body.

In an embodiment, a control system for an animated figure includes a plurality of inertial measurement units (IMUs), each configured to measure one or more motion parameters at a location on the animated figure. The control system also includes a first actuator configured to rotate or translate the animated figure with respect to a first axis. Further, the control system includes a controller communicatively coupled to the plurality of IMUs and the first actuator. The controller is configured to determine a first set of offset factors for the first actuator based on a first subset of the one or more motion parameters. Additionally, the controller is configured to operate the first actuator based on the first set of offset factors to apply a force opposing oscillation of the animated figure.

In an embodiment, a method includes receiving, via a controller, an initial motion profile for operating one or more actuators. Further, the method includes receiving, via the controller, sensor data corresponding to a plurality of inertial measurement unit (IMU) channels from a plurality of IMUs coupled to an animated figure. Additionally, the method includes solving, via the controller, a respective plurality of differential equations describing oscillation of the animated figure based on the sensor data for each IMU channel. Moreover, the method includes deriving, via the controller, a set of offset factors for each actuator of the one or more actuators based on solutions to the plurality of differential equations. Furthermore, the method includes adjusting, via the controller, the initial motion profile based on the offset factors for each actuator to produce an adjusted motion profile. Additionally, the method includes transmitting, via the controller, command signals to each actuator based on the adjusted motion profile.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an embodiment of an animated figure system, in accordance with an embodiment of the present disclosure;

FIG. 2 is a schematic diagram of a perspective view of an embodiment of the animated figure system of FIG. 1, in accordance with an embodiment of the present disclosure;

FIG. 3 is a schematic diagram of a control system of the animated figure system of FIG. 1, in accordance with an embodiment of the present disclosure;

FIG. 4 is a data flow diagram of a control scheme for operating the animated figure system of FIG. 1, in accordance with an embodiment of the present disclosure;

FIG. 5 is a schematic diagram of a portion of the control system of FIG. 3, in accordance with an embodiment of the present disclosure;

FIG. 6 is a flowchart of a method for operating the animated figure system of FIG. 1, in accordance with an embodiment of the present disclosure; and

FIG. 7 is a plot illustrating a measured angular velocity profile and a control command profile versus time for the animated figure system of FIG. 1, in accordance with an embodiment of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. As used herein, the terms “approximately,” “generally,” “substantially,” and so forth, are intended to convey that the property value being described may be within a relatively small range of the property value, as those of ordinary skill would understand. For example, when a property value is described as being “approximately” equal to (or, for example, “substantially similar” to) a given value, this is intended to

convey that the property value may be within at least +/- 5%, within +/- 4%, within +/- 3%, within +/- 2%, within +/- 1%, or even closer, of the given value. Similarly, when a given feature is described as being “substantially parallel” to another feature, “generally perpendicular” to another feature, and so forth, this is intended to convey that the given feature is within at least +/- 5%, within +/- 4%, within +/- 3%, within +/- 2%, within +/- 1%, or even closer, to having the described nature, such as being parallel to another feature, being perpendicular to another feature, and so forth. Mathematical terms, such as “parallel” and “perpendicular,” should not be rigidly interpreted in a strict mathematical sense, but should instead be interpreted as one of ordinary skill in the art would interpret such terms. For example, one of ordinary skill in the art would understand that two lines that are substantially parallel to each other are parallel to a substantial degree, but may have minor deviation from exactly parallel, such as to account for manufacturing tolerances.

It has become more common to create performance displays in venues such as amusement parks, wherein the performance displays may include scenery, special effects, audiovisual features, and other media elements that improve a visitor’s experience. Specifically, such performance displays (e.g., ride environments) may involve animated figures, which may employ robotics, puppeteering, mechanical actuation, hydraulic actuation, electrical actuation, and so forth. Creating immersive (e.g., life-like) movements for such animated figures can be difficult, complicated, and expensive. Additionally, motion of the animated figures may produce unwanted vibrations and/or oscillations about one or more degrees of freedom (DOF). For example, an animated figure may be configured to perform movements (e.g., arm movements, leg movements, turning) that induce a change in momentum of the animated figure. As a result, the animated figure or a portion thereof may oscillate (e.g., wobble, sway, vibrate) back and forth, side to side, or both, at a certain frequency. Additionally, operation of certain mechanisms (e.g., actuators) of the animated figure may produce vibrations. These vibrations may excite a natural frequency of a mechanical assembly or a sub-assembly, causing the animated figure to move in an unwanted oscillatory manner. Furthermore, certain vibrations and oscillations may subject components of the animated figure to cyclic mechanical load (e.g., stress), causing fatigue over time. Accordingly, it is now recognized that improved systems to mitigate vibrations and oscillations in animated figures are desirable to achieve more immersive, efficient, and interesting experiences and narratives in venues such as amusement parks.

In accordance with the present disclosure, an animated figure may be utilized to provide an illusion that an otherwise fictional character, creature (e.g., alien robot), device, or the like is alive or active. For example, a controller (e.g., a performer, a control system) may cause movement of an animated figure based on activation (e.g., physical or electrical activation) of actuators. The controller may cause coordinated movement of specific features of the animated figure (e.g., a head, arms, legs, and/or mouth) to mimic or act out certain movement patterns and thus generate an illusion that the animated figure is essentially alive. The animated figure may be controlled via operation of actuators, motors, and/or other drives that cause movement of the animated figure based on instructions from the controller, which may be remote from, integrated with, or in close proximity to the animated figure. In addition to creating desired movement patterns or profiles, present embodiments may also incorporate features that provide concealment of operational aspects from audience members. Indeed, certain aspects (e.g., motors, actuators, relational movement) related to control and coordinated movement of the animated figure may be concealed (e.g., covered) so that the audience members do not clearly recognize how the movement of the animated figure is being coordinated and achieved in accordance with present embodiments. Further, present embodiments provide such movements or actuations in a manner that reduces undesirable vibrations or oscillations. It should be noted that, as utilized in the present disclosure, the term “animated figure” may include a character, puppet, marionette, animated feature, automated figure, show element, or the like along with supporting components (e.g., a controller, a physical support, a base structure, actuators, motors, sensors, aesthetics, theming material).

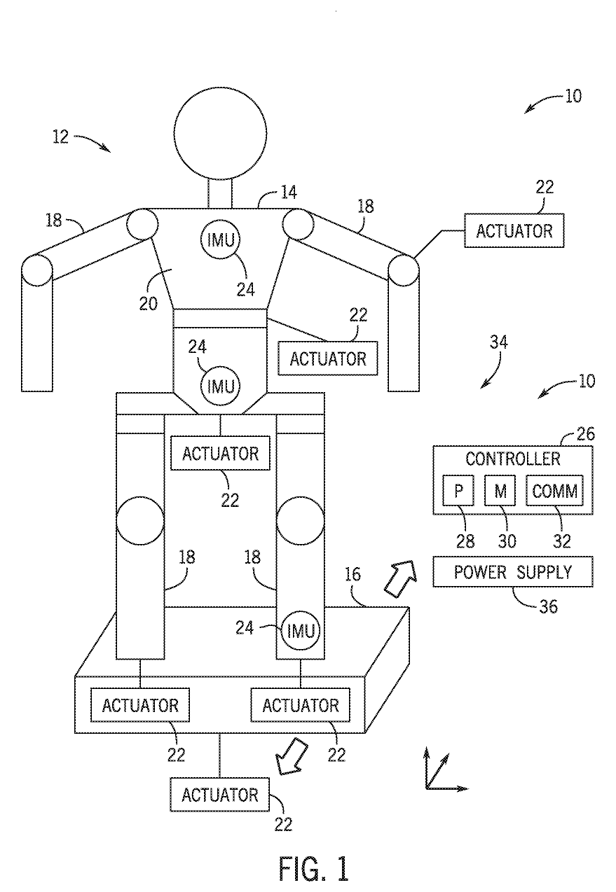

Turning to the drawings, FIG. 1 is a schematic view of an embodiment of an animated figure system 10, in accordance with embodiments of the present disclosure. The animated figure system 10 may include an animated FIG. 12 having a body 14 disposed on or coupled to a platform 16 (e.g., carrier). The body 14 may include various appendages 18 (e.g., limbs, arms, legs) attached to a central body portion 20 (e.g., torso). Furthermore, the animated figure system 10 includes actuators 22 configured to cause various parts of the animated figures system 10 to move (e.g., translate, rotate, sway, walk, gesture). The actuators 22 may include electric motors, engines, hydraulic actuators, pneumatic actuators, linear actuators (e.g., lead screws), rotary actuators, magnetic actuators, and the like.

The animated figure system 10 may be operable to move about multiple degrees of freedom (DOF). For example, the motion of a single appendage 18 (e.g., a leg) of the animated FIG. 10 may be defined by up to three components of translation (e.g., translation along an x, y, and z axis of the appendage 18) and up to three components of rotation (e.g., rotation about the x, y, and z axes of the appendage 18) for a total of up to six DOF of the animated figure system 10 based on an orientation of the single appendage 18. Each other moveable part of the body 14, as well as the platform 16, may provide additional DOFs to the animated figure system 10 as a whole.

In general, each actuator 22 may primarily control (e.g., cause, drive, regulate) motion about one DOF of the animated figure system 10. For example, a first actuator 22 may be a hydraulic actuator that causes the central body portion 20 to rotate (e.g., lean or bend) forward and backward about an x-axis (e.g., lateral axis) of the central body portion 20. As such, the hydraulic actuator may control a first DOF of the animated FIG. 12. Additionally, a second actuator 22 may be a servo motor that causes the central body portion 20 to rotate (e.g., twist) clockwise and counterclockwise about a y-axis (e.g., vertical axis) of the central body portion 20. As such, the servo motor may control a second DOF of the animated FIG. 12. Furthermore, a third actuator 22 may be a motor configured to translate (e.g., drive, slide, push) or rotate (e.g., spin) the platform 16 along an x-, y-, and/or z-axis of the platform 16. For example, the platform 16 may carry the animated FIG. 12 back and forth and/or up and down along a track. As such, the third actuator 22 may control a third DOF of the animated FIG. 12. In some embodiments, multiple actuators 22 may be part of a subsystem (e.g., motion assembly) that works to move a part of the body 14 about multiple DOF. In the above example, the first actuator 22 and the second actuator 22 may be part of a torso motion subsystem.

The animated figure system 10 may further include one or more inertial measurement units (IMUs) 24 (e.g., inertial sensors) configured to sense the motion of the animated FIG. 12. The term “IMU” as used herein refers to a device that measures acceleration, angular velocity, orientation, or a combination thereof. For example, the IMU 24 may include one or more accelerometer components, one or more gyroscope components, and one or more magnetometer components. Alternatively, an accelerometer alone or a gyroscope alone may itself constitute the IMU 24. The IMU 24 may measure its acceleration, angular velocity, and/or orientation with respect to any number (e.g., 1, 2, or 3) of axes. When the IMU 24 is coupled to a point on the body 14 of the animated FIG. 12, the IMU 24 may be considered to measure the acceleration, angular velocity, and/or orientation of that point on the structure (e.g., relative to the Earth).

In some embodiments, each IMU 24 of the one or more IMUs 24 may include an accelerometer, a gyroscope, and a magnetometer for each of three axes (e.g., x, y, and z) of the IMU 24. The animated FIG. 10 may include multiple IMUs 24, such that acceleration, angular velocity, and/or orientation are measured for each of the axes, for each IMU 24. For example, the animated figure system may include three IMUs 24, each configured to measure angular velocity at a respective point about respective x-, y-, and z-axes. Collectively in this case, the three IMUs 24 may measure nine angular velocities in total at three different points. For example, the angular velocity measured at point i with respect to axis j may be ω_{i,j} for i = 1, 2, 3 and j = x, y, z. Additionally or alternatively, one or more of the IMUs 24 may measure linear accelerations a_{i,j} for i = 1, 2, 3 and j = x, y, z. The following discussion emphasizes embodiments that measure angular velocities using the IMUs 24. It should be understood, however, that other embodiments may measure accelerations (e.g., linear acceleration, angular acceleration) instead of or in addition to angular velocities. In any case, whether the IMU data includes accelerations or angular velocities, the processing and control techniques disclosed herein may be applied in similar ways.

The animated figure system 10 further includes a controller 26 coupled to the animated FIG. 12 or the platform 16 or located remotely from the animated FIG. 12. The controller 26 may include a processor 28, a memory 30, and a communication component 32. The memory 30 may include a tangible, non-transitory, computer-readable medium that may store instructions that, when executed by the processor 28, may cause the processor to perform various functions described herein. To this end, the processor 28 may be any suitable type of computer processor or microprocessor capable of executing computer-executable code, including but not limited to one or more field programmable gate arrays (FPGA), application-specific integrated circuits (ASICs), programmable logic devices (PLD), programmable logic arrays (PLA), and the like. It should be appreciated that the controller 26 may include or represent a distributed controller or control system with multiple memory devices and/or multiple processors that operate together to carry out techniques described herein (e.g., one processor performs one operation, another processor performs another operation, and so forth). Thus, as used herein, the memory 30 may include one or more memory devices and the processor 28 may include one or more processors. Additionally, the controller 26 may communicate with the actuators 22, the IMUs 24, a remote controller, a cloud computing system (e.g., a server), and/or other computing devices through the communication component 32. The communication may include control signals for the actuators 22, feedback from sensors in the actuators 22, and/or motion data from the IMUs 24. The communication component 32 may be a wireless or wired communication component that may facilitate communication between the controller 26 and various other controllers and devices via a network, the internet, or the like. For example, the communication component 32 may allow the controller 26 to obtain the data from a variety of data sources (e.g., databases, network, and the like). In some embodiments, the animated FIG. 12 may be remotely controlled through the network. The communication component 32 may use a variety of communication protocols, such as Open Database Connectivity (ODBC), TCP/IP Protocol, Distributed Relational Database Architecture (DRDA) protocol, Database Change Protocol (DCP), HTTP protocol, other suitable current or future protocols, or combinations thereof. Collectively, the actuators 22, the IMUs 24, and the controller 26 may constitute an animated figure control system 34.

Furthermore, the animated figure system 10 may include a power supply 36 configured to supply electrical power to one or more components of the animated figure system 10, such as the actuators 22, the IMUs 24, and/or the controller 26. In some embodiments, the animated figure system 10 may include multiple, separate power supplies to supply power to different components or sets of components. For example, a first power supply may supply power to one or more of the actuators 22 at a particular voltage. A second power supply may supply power to the controller 26 at a different voltage.

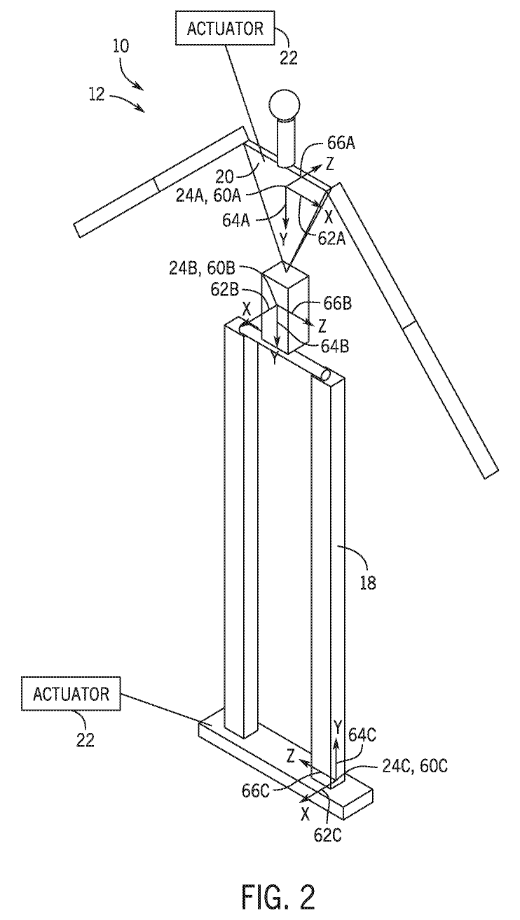

As mentioned above, the IMUs 24 may be mounted at different locations on the animated FIG. 12 to measure the acceleration and or angular velocities with respect to different axes at those locations. FIG. 2 illustrates an example of an animated FIG. 12 having three IMUs 24 mounted at three respective locations. It should be understood that the number of IMUs (e.g., three) and the locations of the IMUs 24 are shown as examples of a possible configuration of the IMUs 24. The locations may be selected based on a tendency of the animated figure to oscillate or vibrate at those points. Other embodiments may include any number of IMUs (e.g., 1, 2, 4, 10) positioned anywhere on the animated FIG. 12.

As shown in FIG. 2, the animated figure system 10 may include a first IMU 24A coupled to a first location 60A (e.g., first point) on the body 14 (e.g., a chest or upper torso portion). The first IMU 24A may measure three angular velocities: ω₁ about an x-axis 62A of the first IMU 24A, ω₂ about a y-axis 64A of the first IMU 24A, and ω₃ about a z-axis 66A of the first IMU 24A. The axes 62A, 64A, and 66A define a frame of reference that is fixed relative to the upper torso or chest portion of the animated FIG. 12. One or more of the actuators 22 may cause the first IMU 24A to move with respect to this frame of reference. For example, the first actuator 22 may tilt the central body portion 20 back and forth at the hips or waist of the animated FIG. 12. As a result, the first IMU 24A may measure a first angular velocity ω₁ of the rotation about the x-axis 62A of the first IMU 24A. In some cases, additional actuators 22 may also influence the first angular velocity ω₁. For example, the second actuator 22 may accelerate the platform carrying the animated FIG. 12 along the z-axis 66C, causing further rotation and, in some cases, oscillation of the central body portion 20 about the x-axis 62A. Other factors, such as external forces, may also influence the first angular velocity ω₁ about the x-axis. Simultaneous to the rotation of the first IMU 24A about the x-axis, the first IMU 24A may also rotate about the y- and z- axes as additional actuators and external forces act upon the animated FIG. 12. Thus, the first IMU 24A may measure angular velocities ω₂ and ω₃ to further characterize the motion of the animated figure at the first location 60A. As the animated FIG. 12 moves, the frame of reference may move relative to the ground. Still, the measured angular velocities ω₁, ω₂, and ω₃ are with respect to the axes of the IMU 24A itself, which may be fixed relative to the chest portion.

The animated figure system 10 may further include a second IMU 24B located at a second location 60B (e.g., second point) on the body 14 (e.g., central body portion 20, lower torso area). The second IMU 24B may measure three angular velocities of the second location 60B: ω₄ about an x-axis 62B of the second IMU 24B, ω₅ about a y-axis 64B of the second IMU 24B, and ω₆ about a z-axis 66B of the second IMU 24B. Additionally, the animated figure system 10 may include a third IMU 24C located at a third location 60C on the body 14 (e.g., appendage 18, foot). The third IMU 24C may measure three angular velocities of the third location 60C: ω₇ about an x-axis 62C of the third IMU 24C, ω₈ about a y-axis 64C of the third IMU 24C, and ω₉ about a z-axis 66C of the third IMU 24C.

In addition to the measure angular velocities, the IMUs 24 may also measure linear accelerations (e.g., a₁, a₂, a₃, …) at each of the first, second, and third locations 60A-C along each of the axes 62A-C, 64A-C, and 66A-C. In some embodiments, the angular velocities and the linear accelerations may be used in combination to control the actuators 22. Furthermore, other embodiments may include additional IMUs 24 positioned at other points of the animated FIGURE(e.g., the head, an arm). Generally, the locations 60 of the IMUs 24 may be selected to best measure inertial effects of expected motion of the animated FIG. 12. For example, the locations 60 may be selected based on a center of gravity of the animated FIG. 12 or proximity to the actuators 22. For example, the IMUs 24 may be positioned at extreme points of the animated FIG. 12, such as the head, arms, tail, or feet.

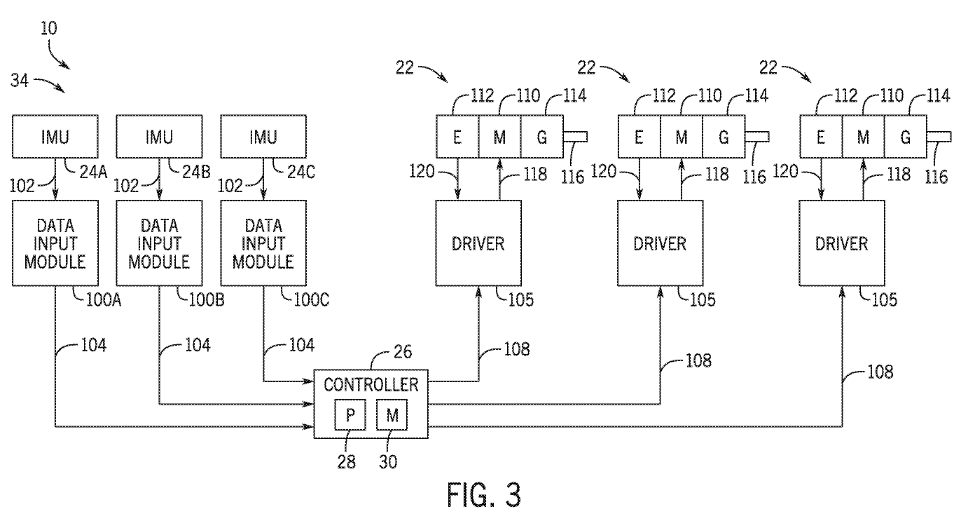

FIG. 3 illustrates an embodiment of the control system 34 configured to implement a control scheme to control the actuators 22, using IMUs 24A, 24B, and 24C to mitigate (e.g., counteract, cancel) oscillations and/or vibrations in the animated FIG. 12 (FIGS. 1 and 2). The control system 34 may also include additional IMUs 24 and actuators 22 not pictured. In general, the controller 26 may receive (e.g., via communication component 32) and/or store (e.g., via memory 30) an initial motion profile indicative of an animation (e.g., sequence of motions) associated with each actuator 22. The initial motion profile may include values of position (e.g., angle in the case of rotary actuators) versus time for each actuator 22. For example, the initial motion profile may include a data structure (e.g., database) indicating desired positions corresponding to multiple discrete points in time (e.g., 15° at t = 1, 20° at t = 2, and so on). Alternatively, the initial motion profile may include one or more equations that describe the desired (e.g., target) position of each actuator 22 as a function of time (e.g., θ₁(t), θ₂(t), and θ₃(t) for three respective actuators 22). In some embodiments, the initial motion profile may also include values or functions indicative of velocity and/or acceleration versus time. Notably, the initial motion profile may not account for oscillatory behavior induced by motion of the animated FIG. 12. For example, the controller 26 may instruct a respective actuator 22 to move to a position prescribed by the initial motion profile. Without implementing any filter or correction to the initial motion profile, the resulting motion may exhibit oscillatory behavior due to shifts in momentum and/or excitation of a natural frequency of the animated FIG. 12.

Techniques disclosed herein utilize the IMUs 24 to generate, via the controller 26, an adjusted motion profile in real time to counteract or cancel oscillations of the animated FIG. 12. For example, the controller 26 may use the collected motion data and a physics model of the animated FIG. 12 to adjust the initial motion profile such that the adjusted motion profile instructs the actuators 22 to counteract the detected oscillations while preserving the intended motion of the initial motion profile.

As shown in FIG. 3, the controller 26 may be communicatively coupled to multiple data input modules 100A, 100B, and 100C corresponding to respective IMUs 24A, 24B, and 24C. Each data input module 100 (e.g., I/O component) may be a serial input module (e.g., a Universal Asynchronous Receiver/Transmitter) configured to receive sensor signals 102 (e.g., analog signals, digital signals, current) from a corresponding IMU 24. The data input modules 100 may process the sensor signals 102 and transmit IMU data 104 (e.g., serial data) representative of the sensor signals 102 to the controller 26 (e.g., via a serial bus).

The controller 26 may be configured to receive and/or store the initial motion profile. For example, the controller 26 may receive the initial motion profile as a user input (e.g., via a user interface or a remote controller). Alternatively or additionally, the initial motion profile may be stored in the memory 30, and the processor 28 may execute a program to access the initial motion profile. Furthermore, the controller 26 may be configured to process the IMU data 104 and generate an adjusted motion profile. The adjusted motion profile may include desired positions, velocities, and/or accelerations of each actuator 22 as a function of time. Based on the adjusted motion profile, the controller 26 may transmit command signals 108 to drivers 105 for each respective actuator 22. The driver 105 (e.g., motor drivers, motor controllers) are configured to provide voltage, current, directionality, and protection to operate the actuators 22 in accordance with the command signals 108. In some embodiments, the driver 105 may implement feedback control (e.g., proportional integral derivative (PID) loops) to regulate a mechanical output (e.g., speed, position) of the actuators 22.

Each actuator 22 may include a motor 110, an encoder 112, a gear assembly 114 (e.g., gear system, gearbox, transmission), and an output shaft 116 or a flange. The respective driver 105 for each actuator 22 may supply power 118 (e.g., current) to the motor 110 based on the command signals 108. The current may be controlled to modulate a speed, direction, and/or commutation of the motor 110. The encoder 112 (e.g., rotary encoder, shaft encoder) is configured to provide information about a position and/or speed of the motor 110. The encoder 112 may transmit encoder signals 120 indicative of the position and/or speed of the motor 110 to the driver 105. In some embodiments, the encoder 112 may be part of the actuator 22 (e.g., integrated within a housing of the actuator 22). Alternatively, the encoder 112 may be external to the actuator 22 and positioned about a rotational axis (e.g., a joint, axle) of the animated FIG. 12 (FIGS. 1 and 2).

The motor 110 may transmit torque (e.g., rotational force) to the output shaft 116 via the gear assembly 114. The gear assembly 114 may increase a torque output or a speed output to the output shaft 116, which is coupled to a mechanical assembly or structure of the animated FIG. 12. In this way, the actuator 22 drives motion of a part of the animated FIG. 12.

In the embodiment shown in FIG. 3, the actuators 22 are electric motor-based actuators. In other embodiments, the actuators 22 may include other types of actuators, such as hydraulic actuators, pneumatic actuators, and the like. In any case, the actuators 22 may receive control signals (e.g., power 118) from respective driver 105 or the controller 26 to produce a mechanical output based on the adjusted motion profile.

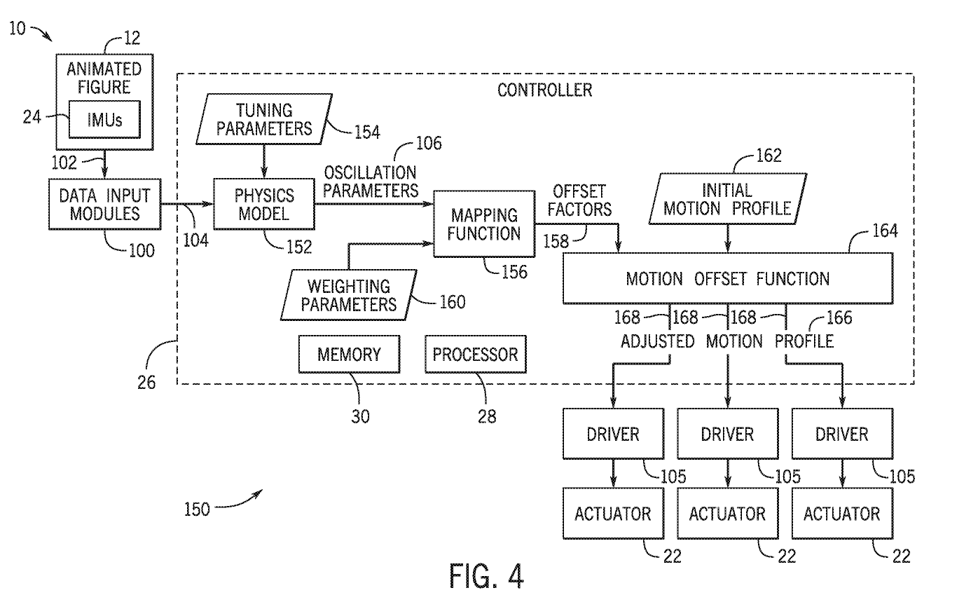

FIG. 4 is a data flow diagram of a control scheme 150 that may be implemented using the controller 26. As discussed above, the IMUs 24 may provide the sensor signals 102 (e.g., analog signals) to the data input modules 100. Each IMU 24 of the one or more IMUs 24 may determine multiple measurements. For example, the IMU 24 may determine any number of angular velocity measurements (e.g., ω₁, ω₂, and ω₃) corresponding to different DOF (e.g., spatial axes). Additionally or alternatively, the IMU 24 may determine any number of linear acceleration measurements (e.g., a₁, a₂, and a₃). Each measurement produced by the IMU 24 may be communicated via a respective IMU channel. The communication may be in the time domain at a certain update frequency (e.g., 100 Hz). The IMU channels may extend from the IMUs 24 to the data input modules 100 and/or to the controller 26. For example, the data input modules 100 may transmit the sensor data 104 to the controller 26 using a separate IMU channel for each measured parameter (e.g., a first channel for ω₁, a second channel for ω₂, and so on).

The data input modules 100 may transmit the sensor data 104 (e.g., serial data) to the controller 26 for processing. The controller 26 may receive, store, and/or access a physics model 152 (e.g., mass-spring-damper model, dynamics model, system model, oscillation model, offset filter) of the animated figure system 10. The physics model 152 may receive each IMU channel as an input and calculate a corresponding oscillation parameter 106 (e.g., adjustment parameter, offset parameter) of one or more oscillation parameters 106 associated with the measured parameter (e.g., ω₁) associated with that IMU channel. The oscillation parameter 106 for a measured parameter may be a number that characterizes the oscillatory behavior or tendency of the animated FIG. 12. In some embodiments, the sensor data 104 may be processed using a signal filter (e.g., low-pass Butterworth filter) as part of the physics model 152.

In some embodiments, the physics model 152 may include a mass-spring-damper model. The mass-spring-damper model may be defined by a second order linear differential equation that describes an expected oscillatory behavior of the animated FIG. 12. Based on the mass-spring-damper model and/or the second-order linear differential equation, the control scheme 150 may predict the oscillatory behavior of the animated FIG. 12. The physics model 152 may also access or receive as an input one or more tuning parameters 154. The tuning parameters 154 may include physical parameters (actual or assumed) of the animated FIG. 12, assumptions about the behavior of the animated FIG. 12, and/or computational parameters associated with computing the oscillation parameters 106. For example, the tuning parameters 154 may include a natural frequency of the animated figure system 10, a damping ratio of the animated figure system 10, a sampling rate of the controller 26, a maximum angular acceleration allowed as an input to the signal filter, a set of parameters, a time constant for the signal filter, and/or a cutoff frequency for the signal filter. Furthermore, the tuning parameters 154 may include gains corresponding to each IMU channel. Polarity (e.g., positive or negative) of the gains may be determined using a tuning process whereby the controller 26 is tested using test gains. The test gains are then adjusted (e.g., tuned) until the calculated oscillation parameters stabilize (e.g., converge toward zero) in response to a motion input (e.g., step input).

The animated FIG. 12 may be modeled as a mass spring damper system defined by a second-order linear differential equation. Certain parameters of the mass spring damper system, such as the damping ratio and the natural frequency, may be provided by the tuning parameters 154. Then, a solution to the second-order linear differential equation may be found for each IMU channel, using the measured parameters as initial conditions. A set of oscillation parameters 106 of the one or more oscillation parameters 106 corresponding to each IMU channel may be derived from each solution. For example, the set of oscillation parameters 106 for one IMU channel may include a first oscillation parameter corresponding to a position (e.g., angle) associated with the IMU 24, a second oscillation parameter corresponding to a velocity (e.g., angular velocity) associated with the IMU 24, and a third oscillation parameter corresponding to an acceleration (e.g., angular or linear acceleration) associated with the IMU 24. A respective set of oscillation parameters 106 of the oscillation parameters 106 may be calculated for each IMU channel for each IMU 24. For example, the first IMU 24A (FIGS. 2 and 3) may correspond to three IMU channels (e.g., ω₁, ω₂, ω₃), each of which is associated with a respective set of oscillation parameters 106 of the one or more oscillation parameters 106, wherein each set of oscillation parameters 106 of the one or more oscillation parameters 106 includes a position factor, a velocity factor, and an acceleration factor. If there are three IMUs 24, each having three IMU channels, there may be a total of nine sets of oscillation parameters 106. Each oscillation parameter of the set of oscillation parameters 106 of the one or more oscillation parameters 106 for an IMU channel may be indicative of a frequency response of the animated FIG. 12 based on the measured parameter of the IMU channel (e.g., ω₁).

Notably, the physics model 152 may not require certain detailed information to model the animated FIG. 12. For example, the physics model 152 need not account for mass properties, moments of inertia, or actuator forces and torques. As such, implementation of the control scheme 150 may be simpler than other techniques. As a result, the control scheme 150 may be easily installed and/or retrofitted onto a variety of animated figure systems 10.

It is presently understood that motion effects of a respective actuator 22 of the actuators 22 may be influenced by one or more of the IMU channels to varying extents. For example, one or more of the IMU channels (e.g., one, two, or three) may influence the functioning of the respective actuator 22 to a greater extent than one or more other IMU channels. In some instances, some of the IMU channels contribute a negligible influence on the operation of a respective actuator 22. To account for the varying degrees to which each measured parameter affects the operation of each actuator 22, the control scheme 150 may apply a mapping function 156 to the oscillation parameters 106. To each actuator 22, the mapping function 156 maps one or more of the one or more oscillation parameters 106 that are pertinent to the operation of that actuator 22. Generally, the oscillation parameters 106 mapped to a respective actuator 22 correspond to a plane in which the respective actuator 22 would act to induce or attenuate oscillation. For example, oscillation parameters 106 which correspond to angular velocities in a vertical plane (e.g., x-y plane) may be mapped to a respective actuator 22 that acts in the same vertical plane or a plane parallel to the vertical plane.

For each actuator 22, the mapping function 156 may calculate a weighted sum of the oscillation parameters 106 mapped to the actuator 22. For example, each oscillation parameter 106 mapped to the actuator 122 may be multiplied by a respective weighting parameter 160 (e.g., gain) of one or more weighting parameters 160. Then, the mapping function 156 may calculate the sum of the weighted oscillation parameters (i.e., each respective oscillation parameter 106 multiplied by their respective weighting parameter 160). The resulting sum of the weighted oscillation parameters is referred to herein as an offset factor 158. The offset factor 158 for a respective actuator 22 may include a position offset value, a velocity offset value, an acceleration offset value, or a combination thereof. In this way, the mapping function 156 may calculate an offset factor 158 for each actuator 22. The offset factor 158 may be used to augment actuator commands in real time to counter-animate against expected oscillation in the plane of the actuator 22. Notably, the offset factors 158 are derived from the oscillation parameters 106, and ultimately from the solutions to the second order linear differential equation defining the mass spring damper system of the physics model 152.

An initial motion profile 162 may define a desired motion or sequence of motions of the animated figure system 10. For example, the initial motion profile 162 may include a set of desired position, velocity, and/or acceleration values for each actuator 22 at defined points in time. In some embodiments, the initial motion profile 162 may be stored on the memory 30 and accessed as part of a program or script executed by the processor 28. Alternatively, the controller 26 may receive (e.g., via the communication component 32) a user input (e.g., a stream of input) and interpret the initial motion profile 162 from the user input. As discussed above, the initial motion profile 162 may not account for oscillation of the animated FIG. 12. Therefore, the control scheme 150 may include a motion offset function 164 configured to augment the initial motion profile 162 with the offset factors 158. Based on the initial motion profile 162 and the offset factors 158, the motion offset function 164 may calculate an adjusted motion profile 166. For example, the motion offset function 164 may include a mathematical operation (e.g., multiplication) or transformation of the initial motion profile 162 based on the offset factors 158. The transformation may include the superposition of a forcing function on the initial motion profile 162. The forcing function for each actuator 22 may oppose the oscillation of the body 14 (FIG. 1) as predicted by the physics model 152. The result is the adjusted motion profile 166 that includes adjusted position, velocity, and/or acceleration values for each actuator 22. In other words, the motion offset function 164 may superpose the forcing function onto the initial motion profile 162 to produce the adjusted motion profile 166, where the forcing function is determined based on the sensor data 104, the physics model 152, the tuning parameters 154, the oscillation parameters 106, the weighting parameters 160, the mapping function 156, and/or the offset factors 158. The position, velocity, and/or acceleration values may be transmitted as command signals 168 (e.g., respective command signals 168) to the driver 105 (e.g., each driver 105) and/or the actuators 22 (e.g., each actuator 22) to implement the adjusted motion profile 166.

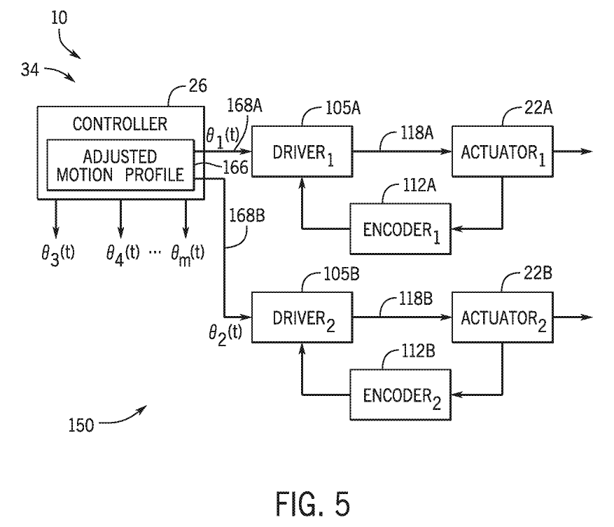

FIG. 5 illustrates a portion of the control system 34 for implementing the adjusted motion profile 166. As discussed above, the controller 26 augments the initial motion profile 162 (FIG. 4) based on the sensor data 104 (FIG. 4) from the IMUs 24 (FIGS. 1-4) to generate the adjusted motion profile 166. The adjusted motion profile 166 defines the motion of the animated FIG. 12 (FIGS. 1, 2, and 4) to be executed by the actuators 22 (e.g., a first actuator 22A, a second actuator 22B, collectively referred to as the actuators 22 or each actuator 22). To this end, the adjusted motion profile 166 may include information regarding position, velocity, and/or acceleration of each actuator 22 (FIGS. 1-4) over time. This information may be represented using graphs, equations, discrete functions, commands, and/or any other suitable form of defining motion versus time. In the illustrated embodiment of FIG. 5, the adjusted motion profile 166 provides, for each actuator 22, the command signal 168 indicating a desired position as a function of time. Additionally or alternatively, the command signals 168 may include velocity (e.g., linear or angular) or acceleration (e.g., linear or angular).

As shown, a first command signal 168A includes a reference input θ₁(t) based on the adjusted motion profile 166. The reference input θ₁(t) may correspond to an original input of the initial motion profile 162 (FIG. 4), augmented by the offset factors 158 (FIG. 4) via the motion offset function 164 (FIG. 4). For example, the original input may have included an instruction to move the first actuator 22A to a certain position at a certain rate in accordance with the initial motion profile 162 (FIG. 4). Then, the controller 26 may receive the sensor data 104 (FIG. 4) from the IMUs 24 (FIGS. 1-4), determine the oscillation parameters 106 (FIG. 4) using the physics model 152 (FIG. 4), map the oscillation parameters 106 (FIG. 4) to the relevant actuators 22 to determine the offset factors 158 (FIG. 4), and then apply (e.g., multiply) the offset factors 158 (FIG. 4) to the original input to produce the reference input θ₁(t).

A first driver 105A, upon receiving the reference input θ₁(t), may adjust a first supply of power 118A (e.g., current) to the first actuator 22A to cause the first actuator 22A to move toward the position indicated by the reference input θ₁(t). As the first actuator 22A moves, a first encoder 112A may measure the actual position of the first actuator 22A. This measured position may be fed back to the first driver 105A to enable feedback control of the first actuator 22A. For example, the first driver 105A may include a feedback controller (e.g., proportional integral derivative (PID) controller) configured to adjust the position of the first actuator 22A based on an error between the reference input θ₁(t) and the position measured by the first encoder 112A.

Additionally, the controller 26 may transmit a second reference input θ₂(t) to the second driver 105B to control the second actuator 22B. The second reference input θ₂(t) may be calculated independently from first reference input θ₁(t), and the second actuator 22B may operate independently of the first actuator 22A. The second actuator 22B may also be controlled using a feedback control loop. In similar fashion the controller 26 may control any number (e.g., m) of actuators 22 by producing that number of reference inputs θₘ(t).

The control scheme 150 operates to recognize the oscillatory behavior of the animated FIG. 12 (FIGS. 1, 2, and 4) by processing the sensor data 104 (FIG. 4) from the IMUs 24 (FIGS. 1-4). Based on knowledge of the angular velocity and/or linear acceleration of the animated FIG. 12 (FIGS. 1, 2, and 4) at the locations of the IMUs 24 (FIGS. 1-4), the controller 26 may compute the offset factors 158 (FIG. 4) through which the initial motion profile 162 (FIG. 4) is filtered. The resulting adjusted motion profile 166 includes reference inputs to each of the actuators 22, causing the actuators 22 to move to counteract the oscillation while sustaining the underlying desired motion.

As part of an amusement attraction, the animated figure system 10 may operate according to a predetermined program (e.g., script, motion profile) known ahead of time. In some embodiments, the oscillation parameters 106 (FIG. 4) and/or the offset factors 158 (FIG. 4) may be recorded through a first run through the program. Upon subsequent runs, recorded oscillation parameters 106 (FIG. 4) and/or offset factors 158 (FIG. 4) may be provided as feed-forward components to the control scheme 150. For example, the controller 26 may implement a feed-forward gain to control a magnitude of the offset factors 158 (FIG. 4) used from the previous run. The feed-forward component may be used in addition to the real-time offset factors 158 (FIG. 4). Each successive run may improve the performance of the animated figure system 12 as more feed-forward information is collected.

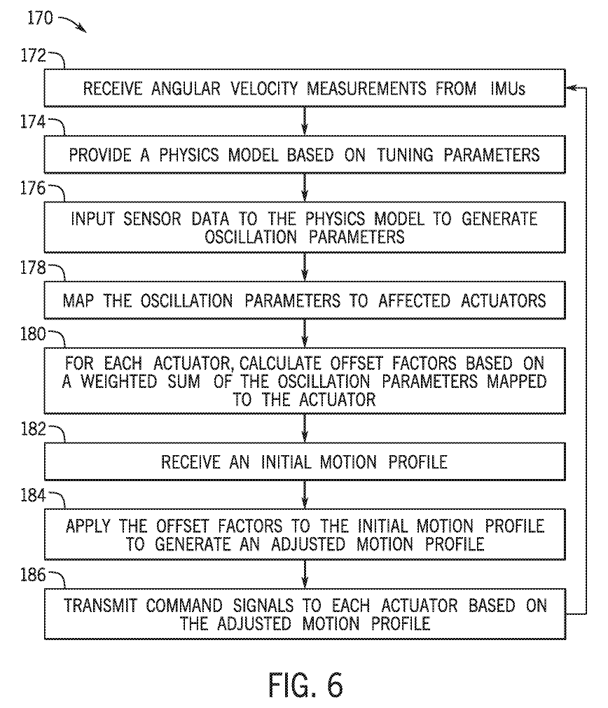

FIG. 6 illustrates a method 170 for mitigating oscillation of the animated FIG. 12 (FIGS. 1, 2, and 4). The method 170 may be performed by the controller 26 (FIGS. 1-5) (e.g., using the processor 28 (FIGS. 1, 3, and 4). For example, the memory 30 (FIGS. 1, 3, and 4) may include a tangible, non-transitory, computer-readable medium that may store instructions that, when executed by the processor 28 (FIGS. 1, 3, and 4), cause the processor to perform the method 170. At block 172, the controller 26 (FIGS. 1, 3, and 4) may receive sensor data from one or more IMUs 24 (FIGS. 1-4) coupled to the animated FIG. 12 (FIGS. 1, 2, and 4). Each of the IMUs 24 (FIGS. 1-4) may measure one or more motion parameters, such as angular velocity and/or linear acceleration, about one or more axes. In this embodiment, the animated figure system 10 (FIGS. 1-5) includes three IMUs 24 (FIGS. 1-4), each measuring angular velocities about their respective x, y, and z axes.

The controller 26 (FIGS. 1-5) may receive the sensor data via one or more data input modules (e.g., serial input modules) corresponding to the one or more IMUs 24 (FIGS. 1-4). The data input modules may facilitate communication between the IMUs 24 (FIGS. 1-4) and the controller 26 (FIGS. 1-5) by transmitting the sensor data from one or more IMU channels corresponding to the one or more motion parameters. For example, the controller 26 (FIGS. 1-5) may receive three IMU channels corresponding to the three angular velocities measured by one IMU 24 (FIGS. 1-4). Additionally, the controller 26 (FIGS. 1-5) may receive another three IMU channels corresponding to three angular velocities measured by an additional IMU 24 (FIGS. 1-4). In some embodiments, the controller 26 (FIGS. 1-5) may filter the sensor data using a low-pass Butterworth filter.

At block 174, the controller 26 (FIGS. 1-5) may provide a physics model representing the oscillatory behavior of the animated FIG. 12 (FIGS. 1, 2, and 4). The physics model may be stored in the memory 30 (FIGS. 1, 3, and 4) of the controller 26 (FIGS. 1-5) or another computing device (e.g., a remote server, cloud computing environment). The physics model may include a second-order mass-spring-damper filter defined by a set of tuning parameters including a natural frequency and a damping ratio of the mass-spring-damper system. The tuning parameters may also be stored in the memory 30 (FIGS. 1, 3, and 4).

At block 176, the controller 26 (FIGS. 1-5) may process the sensor data from each IMU channel using the physics model. Based on the mass-spring-damper filter, the controller 26 (FIGS. 1-5) may calculate a set of oscillation parameters for each IMU channel. Each set of oscillation parameters may include a position parameter, a velocity parameter, and/or an acceleration parameter.

At block 178, the controller 26 (FIGS. 1-5) may map one or more of the sets of oscillation parameters to each actuator based on whether the those sets of oscillation parameters would influence operation of the actuator. For example, in some embodiments, only the sets of oscillation parameters corresponding to IMU channels measuring angular velocity in a horizontal plane would map to an actuator that acts along a plane parallel to the horizontal plane. The remaining sets of oscillation parameters may be considered negligible for the purpose of augmenting commands to the actuator.

At block 180, the controller 26 (FIGS. 1-5) may calculate a weighted sum of the oscillation parameters based on their relative influence on the oscillation of the animated FIG. 12 (FIGS. 1, 2, and 4). For example, the controller 26 (FIGS. 1-5) may access weighting parameters (e.g., gains) stored as part of the tuning parameters and/or in the memory 30 (FIGS. 1, 2, and 4). Each set of oscillating parameters may correspond to a weighting parameter. Each set of oscillating parameters mapped to a particular actuator may be multiplied by the corresponding weighting parameter. Then, the sum of the weighted oscillating parameters is taken to create one set of offset factors for the actuator. The set of offset factors may include a position offset value, a velocity offset value, and/or an acceleration offset value.

At block 182, the controller 26 (FIGS. 1-5) may receive or access an initial motion profile (e.g., base profile). For example, the controller 26 (FIGS. 1-5) may receive a user input (e.g., via a user interface) to cause the animated FIG. 12 (FIGS. 1, 2, and 4) to perform a motion. Alternatively, the initial motion profile may be part of a pre-determined program (e.g., script) stored in the memory 30 (FIGS. 1, 3, and 4). For each actuator, the initial motion profile may include values or expressions for position, angular velocity, and/or acceleration versus time.

At block 184, the controller 26 (FIGS. 1-5) may apply the offset factors to the initial motion profile to generate an adjusted motion profile. For example, each prescribed position value for an actuator in the initial motion profile may be multiplied or otherwise affected by the position offset value calculated for the actuator. In this way, the adjusted motion profile may act as a filter to augment the initial motion profile based on the offset factors.

At block 186, the controller 26 (FIGS. 1-5) may transmit command signals to each actuator based on the adjusted motion profile. The command signals, derived based on the initial motion profile and the IMU channels, may counteract any expected oscillation while sustaining the underlying motion pattern defined by the initial motion profile. In this way, oscillation of the animated FIG. 12 (FIGS. 1, 2, and 4) may be reduced. Upon completion of block 186, the method 170 may loop continuously back to block 172. In this way, the method 170 may provide a continuous control loop for the actuators by using data from the IMUs as feedback to produce the command signals.

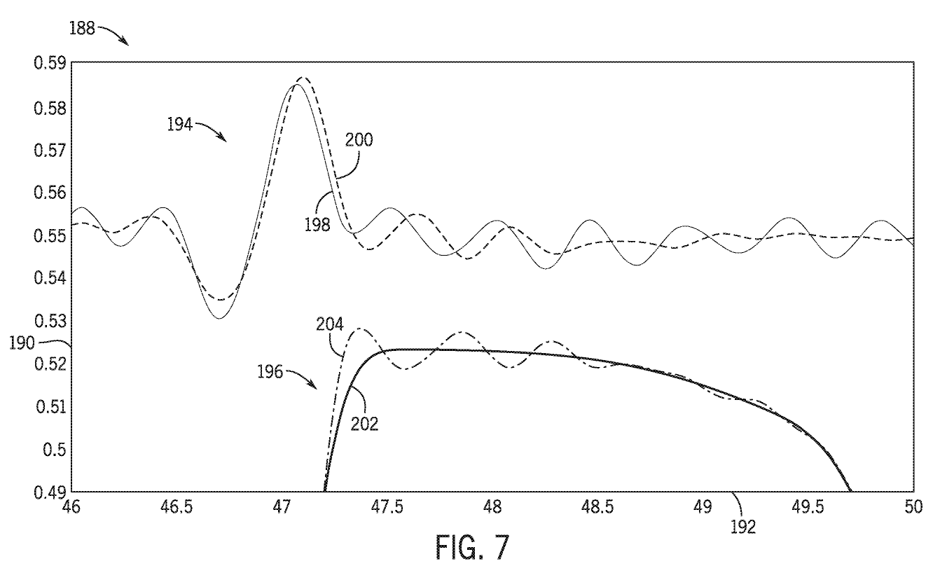

FIG. 7 illustrates a plot 188 of a control command and an angular velocity of an actuator (e.g., Y-axis 190, normalized) versus time (e.g., X-axis 192, seconds) as a measured angular velocity profile 194 and a position command profile 196. For clarification purposes, to view both the position command and angular velocity of an IMU (e.g., IMU 24 associated with the body 14 of the animated FIG. 12 (FIG. 1)), the Y-axis 190 is normalized to show behavior of both characteristics within a single plot (e.g., plot 188). The measured angular velocity profile 194 may correspond to the angular velocity of a portion of the animated FIG. 12 (FIGS. 1, 2, and 4), such as the angular velocity of an IMU positioned in the body of the animated FIG. 12 (FIGS. 1, 2, and 4). The measured angular velocity profile 194 includes the normalized angular velocity profile of the IMU without vibration compensation, identified as a solid line 198 (e.g., an unattenuated measured angular velocity profile) and a normalized angular velocity profile of the IMU with active vibration compensation, identified as a dotted line 200 (attenuated measured angular velocity profile).

The normalized angular velocity of the IMU without vibration compensation (i.e., the solid line 198) is augmented to produce an adjusted angular motion (e.g., dotted line 200) in response to detected disturbance (e.g., oscillations) of the animated FIG. 12 (FIGS. 1, 2, and 7). As shown, the motion profile instructs the actuator to adjust its position over time. As the actuator moves according to the profile, oscillation may be induced (e.g., introduced) to the animated FIG. 12, resulting in a deviation of the angular velocity (e.g., as measured by the IMU(s)) from the prescribed position defined by the motion profile. A control scheme (e.g., control scheme 150 of FIGS. 4 and 5) for the actuator may recognize the oscillatory behavior based on sensor data from one or more IMUs. Then, the control scheme may instruct the actuator to apply a force or motion (e.g., in the form of a position command) opposing the oscillation of the animated FIG. 12 (e.g., 1, 2, and 7). For example, if the command profile (e.g., a dotted line 204) would cause a controller to transmit certain control signals to the actuator, the control scheme may filter or apply a correction factor to the control signals to counteract the oscillation of the animated figure. As a result, the measured angular velocity of the IMU may converge to the desired motion profile (e.g., the dotted line 200). As will be appreciated, the oscillations of the dotted line 200 (i.e., the normalized angular velocity of the IMU with vibration compensation) decrease or decay over time and are at least partly out of phase relative to the solid line 198 (i.e., normalized angular velocity profile of the IMU without vibration compensation).

The position command profile 196 may correspond to the position command to the actuator. The position command profile 196 includes the position command and/or an attenuation profile, identified as a solid line 202 (e.g., attenuated position command profile), and a position command without attenuation, identified as a dotted line 204 (e.g., unattenuated position command profile).

The unattenuated position command profile (i.e., the dotted line 204) is augmented to produce an adjusted position profile in response to detected disturbance (e.g., oscillation) of the animated FIG. 12 (FIGS. 1, 2, and 7). As shown, the unattenuated position command profile (e.g., the dotted line 204) instructs the actuator to adjust its position over time. As the actuator moves according to the profile, oscillation may be induced (e.g., introduced) to the animated figure, resulting in a deviation of the angular velocity as measured or sensed by the IMU(s) from the prescribed position defined by the motion profile. A control scheme (e.g., control scheme 150 of FIGS. 4 and 5) for the actuator may recognize the oscillatory behavior based on sensor data from one or more IMUs. Then, the control scheme may instruct the actuator to apply a force or motion (e.g., in the form of the position command) opposing the oscillation of the animated figure. For example, if the command profile would cause a controller to transmit certain control signals to the actuator, the control scheme may filter or apply a correction factor to the control signals to counteract the oscillation of the animated figure. As will be appreciated, the oscillations of the dotted line 204 (i.e., the position command with attenuation) converges with the solid line 202 (i.e., desired motion profile).

While only certain features of the invention have been illustrated and described herein, many modifications and changes will occur to those skilled in the art. It is, therefore, to be understood that the appended claims are intended to cover all such modifications and changes as fall within the true spirit of the invention.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]…” or “step for [perform]ing [a function]…”, it is intended that such elements are to be interpreted under 35 U.S.C. 112(f). However, for any claims containing elements designated in any other manner, it is intended that such elements are not to be interpreted under 35 U.S.C. 112(f).

1. An animated figure system, comprising:
an animated figure comprising a body;
one or more actuators configured to move the body according to a motion profile;
a plurality of inertial measurement units (IMUs) coupled to the body at a respective plurality of locations, wherein each IMU of the plurality of IMUs is configured to measure one or more motion parameters of the body; and
a controller communicatively coupled to the one or more actuators and the plurality of IMUs, wherein the controller is configured to:
determine one or more offset factors based at least on the one or more motion parameters;
augment the motion profile based on the one or more offset factors to produce an adjusted motion profile; and
operate the one or more actuators according to the adjusted motion profile to apply a force opposing oscillation of the body.

2. The animated figure system of claim 1, wherein the one or more motion parameters of each IMU comprise a first angular velocity about a first axis of the IMU, a second angular velocity about a second axis of the IMU, and a third angular velocity about a third axis of the IMU.

3. The animated figure system of claim 1, wherein the controller is configured to determine the one or more offset factors based on a natural frequency of the body, a damping ratio of the body, and the one or more motion parameters.

4. The animated figure system of claim 1, wherein the adjusted motion profile comprises a forcing function superposed on the motion profile, opposing the oscillation of the body.

5. The animated figure system of claim 1, wherein the controller is configured to predict the oscillation of the body by modeling the body as mass spring damper system.

6. The animated figure system of claim 5, wherein the mass spring damper system is defined by a second-order linear differential equation, and the one or more offset factors are derived from a solution to the second-order linear differential equation.

7. The animated figure system of claim 1, wherein:
the body of the animated figure comprises a torso;
the one or more actuators comprise a first actuator configured to rotate the torso about a first axis; and
the one or more actuators comprise a second actuator configured to rotate the torso about a second axis orthogonal to the first axis.

8. The animated figure system of claim 1, comprising one or more drivers each configured to implement a proportional integral derivative (PID) loop to control the one or more actuators.

9. The animated figure system of claim 1, wherein the body is disposed on a moving platform driven by at least one of the one or more actuators, and the moving platform is configured to rotate the body, translate the body, or both.

10. A control system for an animated figure, the control system comprising:
a plurality of inertial measurement units (IMUs), each configured to measure one or more motion parameters at a location on the animated figure;
a first actuator configured to rotate or translate the animated figure with respect to a first axis; and
a controller communicatively coupled to the plurality of IMUs and the first actuator, wherein the controller is configured to:
determine a first set of offset factors for the first actuator based on a first subset of the one or more motion parameters; and
operate the first actuator based on the first set of offset factors to apply a force opposing oscillation of the animated figure.

11. The control system of claim 10, comprising a second actuator configured to rotate or translate the animated figure with respect to a second axis, wherein the controller is configured to:
determine a second set of offset factors for the second actuator based on a second subset of the one or more motion parameters; and
operate the second actuator based on the second set of offset factors to apply an additional force opposing oscillation of the animated figure.

12. The control system of claim 10, wherein the controller is configured to:
receive a motion profile defining a target motion of the first actuator;
augment the motion profile based on the first set of offset factors to produce an adjusted motion profile; and
operate the first actuator according to the adjusted motion profile to apply the force opposing the oscillation of the animated figure.

13. The control system of claim 12, wherein the adjusted motion profile comprises a forcing function superposed on the motion profile, opposing the oscillation of animated figure.

14. The control system of claim 10, wherein the controller is configured to:
model the animated figure using a second-order linear differential equation;
solve the second-order linear differential equation for each motion parameter of the one or more motion parameters; and
determine the first set of offset factors based on a solution to the second-order linear differential equation.

15. The control system of claim 10, comprising a driver communicatively coupled to the first actuator, wherein the first actuator comprises an encoder configured to provide a position of the first actuator as feedback to the driver.

16. The control system of claim 15, wherein the driver is configured to implement proportional integral derivative (PID) control of the first actuator using the feedback.

17. A method, comprising:
receiving, via a controller, an initial motion profile for operating one or more actuators;
receiving, via the controller, sensor data corresponding to a plurality of inertial measurement unit (IMU) channels from a plurality of IMUs coupled to an animated figure;
solving, via the controller, a respective plurality of differential equations describing oscillation of the animated figure based on the sensor data for each IMU channel;
deriving, via the controller, a set of offset factors for each actuator of the one or more actuators based on solutions to the plurality of differential equations;
adjusting, via the controller, the initial motion profile based on the offset factors for each actuator to produce an adjusted motion profile; and
transmitting, via the controller, command signals to each actuator based on the adjusted motion profile.

18. The method of claim 17, wherein the adjusted motion profile comprises a forcing function superposed on the initial motion profile, opposing the oscillation of animated figure.

19. The method of claim 17, comprising predicting, via the controller, oscillation of the animated figure based on the solutions to the plurality of differential equations.

20. The method of claim 17, comprising:
receiving, via the controller, feedback indicative of positions of the one or more actuators; and
adjusting, via the controller, the command signals based on the feedback using a proportional integral derivative (PID) loop.
